(19) United States
(12) Patent Application Publication
(10) Pub. No.: US 2020/0113020 A1
(43) Pub. Date: Apr. 9, 2020

(54) LOW POWER HIGH-EFFICIENCY HEATING ELEMENT

(71) Applicant: Amen Dhyllon, Wynnewood, PA (US)

(72) Inventor: Amen Dhyllon, Wynnewood, PA (US)

(73) Assignee: Serendipity Technologies LLC, Wynnewood, PA (US)

(21) Appl. No.: 16/669,353

(22) Filed: Oct. 30, 2019

Related U.S. Application Data
(63) Continuation-in-part of application No. 16/152,475, filed on Oct. 5, 2018, now abandoned.

(51) Int. Cl. H05B 3/18; H05B 3/64

(52) U.S. Cl. CPC H05B 3/18; H05B 2203/013; H05B 3/64

(57) ABSTRACT

A heating element comprising a metal ribbon coated with heat resistant coatings adapted to produce radiant heat rapidly and with higher efficiency than prior known heating elements.

### RELATED APPLICATIONS

The present application is a continuation-in-part of U.S. application Ser. No. 16/152,475 titled LOW POWER HIGH-EFFICIENCY DC-POWERED HEATING ELEMENT filed 5 Oct. 2018

### FIELD OF THE INVENTION

The invention is related to electrical heating elements made preferably from tungsten, or in other embodiments, of steel, copper, Nichrome, Iron-Chromium-Aluminum alloys, Cupronickel, and Platinum, and coated with at least the following: zirconium carbide, zirconium dioxide, hafnium carbide and tantalum carbide, and with various combinations of other heat-insulating and electrically-insulating materials.

### BACKGROUND

It is well known to pass an electrical current through a metal filament to produce heat and/or light, and various prior art methods and devices are known including, for example, Lo at al. (U.S. Pat. No. 6,327,428), Manov et al. (U.S. Pat. No. 5,641,421), Etter (U.S. Pat. No. 3,029,360) and Pollak (US2002/0006275A1).

Many heating appliances such as electric furnaces, electric ovens, electric heaters and others, utilize electrical energy to produce the heat. A heating element is used to convert the electrical energy in the form of heat. The electric current (I) is ‘consumed’ by resistance (Ω) over a time (t) in seconds. E=I²Rt Joules

The performance and life of a heating element depends on properties of the material used. The relevant and desirable properties for heating elements are: high melting point, and freedom from oxidation in open atmosphere. Also desirable are high tensile strength, ductility to enable drawing wire, high resistivity, and low temperature coefficient of resistance.

The following materials are commonly used for manufacturing heating elements: Tungsten, Nichrome, Iron-Chromium-Aluminum alloys, Cupronickel, and Platinum.

Tungsten is the preferred material for the heating element.

Nickle-Chromium alloys (“Nichrome”) is often used to make heating elements for electric heaters and furnaces. Nichrome is a very good material for making a heating element because it has a comparatively high resistance. When the heating element is heated first time, chromium reacts with atmospheric oxygen to form a layer of chromium oxide on the outer surface of heating element. This layer of chromium oxide works as a protective layer for element and protect the material beneath this layers against oxidation, preventing the heating element from oxidizing and burning out. Heating elements made of Nichrome can be used for continuous operation at a temperature up to 1200° C. It generally has the composition:

Ni=80%+Cr=20%

Heating elements made of Nichrome may have the following properties:

### Resistivity: 40 μΩ-cm

Temperature coefficient of resistance: 0.00041° C.
Melting point: 1400° C.
Specific gravity: 8.4 gm/cm3
High resistance to oxidation.

Iron-Chromium-Aluminum (Fe—Cr—Al), also called KANTAHL™ alloys are used in wide range of heating applications.

Composition of Kanthal is generally:

Fe−(62.5-76)%+Cr−(20-30)%+Al−(4-7.5)%

Kanthal has the following properties:

### Resistivity at 20° C.: 145 μΩ-cm

Temperature coefficient of resistance at 20° C.: 0.000001/° C.
Melting point: 1500° C.
Specific gravity: 7.10 gm/cm3
High resistance to oxidation

When Kanthal is heated first time, the aluminum of alloy react with oxygen of atmosphere and form a layer of aluminum oxides over heating element. This layer of aluminum oxides, is an electrical insulator but have good thermal conductivity. This electrical insulating layer of aluminum make the heating element shock proof. Heating elements made of Kanthal can be used for continuous operation at a temperature up to 1400° C. Therefore, it is very much suitable for making heating elements for Electric Furnaces used for heat treatment in ceramics, steels, glass and electronic industries.

Copper-nickel alloys (called “Cupronickel” or “copper-nickel”) is an alloy made by composing copper, nickel and strengthening elements such as iron and manganese.

Composition of Cupronickel is generally about:

Cu=66%+Ni=30%+Fe=2%+Mn=2%

The above percentages may be plus or minus 20% of the stated percentage in every case.

Properties of Cupronickel

### Resistivity at 20° C.: 50 μΩcm

Temperature coefficient of resistance at 20-500° C.: 0.00006/° C.
Melting point: 1280° C.
Specific gravity: 8.86 gm/cm3
High resistance to oxidation

Cupronickel has a high electrical resistance, high ductility and good corrosion resistance. Heating elements made of “Cupronickel” can be used for continuous operation at a temperature up to 600° C.

Platinum is least reactive metal and has remarkable resistance to corrosion, even at high temperature.

Properties of Platinum (Pt)

### Resistivity at 20° C.: 10.50 μΩ-cm

Temperature coefficient of resistance at 20° C.: 0.00393/° C.
Melting point: 1768.30° C.
Specific gravity: 21.45 gm/cm3
High resistance to oxidation
High ductility
Highly malleable
Good mechanical strength
Good stability with temperature and mechanical stress

Platinum is used in electrical engineering and laboratory furnaces with a working temperature of 1300° C.

Power: Heating element power usage is always a key factor is heating elements. Generally, AC power is used to heat the element, requiring a considerable input of power. Electric resistance heating is 100% energy efficient in the sense that all the incoming electric energy is converted to heat. However, most electricity is produced from coal, gas, or oil generators that convert only about 30% of the fuel's energy into electricity, producing heat at relatively low efficiency. AC heaters require applying a large voltage across a resistor to produce heat. The power (P) is calculated by the equation P=IV (where V=voltage and I—current) and voltage is calculated using the equation V=IR (where R is resistance), so P=I²R. To the higher the resistance the higher the voltage required. A typical electric heater will use between 1000 and 3000 Watts.

AC power can also be said to be more dangerous than DC current since the voltage alternates, it can cause current to enter and exit your body even without a closed loop, since your body (and what ground it's attached to) has capacitance. DC cannot do that.

There is clearly a need for a more efficient and safer DC-powered type of heater in which the element can be heated to very high temperatures using only a few watts.

### BRIEF DESCRIPTION OF THE INVENTION

The invention encompasses a heater element comprising an electrically conducting filament coated with at least the following substances: a hafnium compound and a zirconium compound. In preferred embodiments the heater filament is coated with at least hafnium diboride and zirconium diboride, or, for example with at least hafnium carbide and zirconium dioxide.

In some embodiments the invention encompasses a heating element comprising a coated metal ribbon which in some embodiments may be wound around an insulating armature and may be adapted to conduct a DC current, and thereby produce radiant heat rapidly and with higher efficiency than prior known heating elements.

Specifically, the invention provides a coated heating element adapted to conduct a DC (rather than AC) current. The present invention is more efficient and safer than the prior art, and the heating element can be heated to very high temperatures using only, for example 55 W-60 W. In a broad aspect, the invention does not require a winding armature but in its fundamental form comprises a metal conductor of any shape, coated with an insulating material such as graphite and zirconia, and/or graphite and/or silica carbide. An important aspect is that the heating element can become very hot with a relatively small energy input and small current.

The heating filament may be a wire or ribbon and may be made from one or a combination of Tungsten, Nichrome, Iron-Chromium-Aluminum alloys, Cupronickel, palladium, and platinum. Tungsten, copper, aluminum and titanium are the preferred material for the heating element.

The heating filament of the invention is coated with substances that act as an insulator, both to heat and or electricity. The coating may be made from one or more substances such as zirconium dioxide and hafnium carbide and tantalum carbide and zirconium carbide.

Coatings may also be made from wire enamels or thermal ceramics providing thermal insulation. Coatings may include coating with at least hafnium diboride and zirconium diboride, or, for example with at least hafnium carbide and zirconium dioxide.

Ultra-high-temperature ceramics (UHTCs) may be used in the invention. UHTCs are a class of refractory ceramics that offer excellent stability at temperatures exceeding 2000° C. UHTCs include borides, carbides, nitrides, and oxides of early transition metals. These include early transition metal borides such as hafnium diboride (HfB2) and zirconium diboride (ZrB2). Additional UHTCs under investigation for TPS applications include hafnium nitride (HfN), zirconium nitride (ZrN), titanium carbide (TiC), titanium nitride (TiN), thorium dioxide (ThO2), tantalum carbide (TaC) and their associated composites. Any of these may be used in the invention. Silicon carbide coatings may also be used.

A number of prior art references are known which disclose various heating elements, some of which are coated with various heat-resistant materials. For example Lo at al (U.S. Pat. No. 6,327,428), Manov et al. (U.S. Pat. No. 5,641,421), Etter (U.S. Pat. No. 3,029,360) and Pollak (US2002/0006275A1). Etter discloses coating of a heating wire with zirconium carbide. But it does not disclose a coating of graphite or silica carbide or hafnium carbide or tantalum carbide or titanium diboride or yttrium aluminum garnet or any combination of these elements as claimed in the present application.

In certain embodiments, the present invention includes heating elements coated with one or more of these compounds in various combinations. In a specific embodiment, the present invention recites heating elements coated with at least the following: zirconium carbide, zirconium dioxide, hafnium carbide and tantalum carbide.

It is believed by the applicant that this combination of coatings is unique and novel in the field of coating a heating filament, and has been selected for its effect on heat production using low energy input through a DC current.

### BRIEF DESCRIPTION OF THE FIGURES

FIG. 1 A schematic of a heating element wound around an insulated armature scaffold.

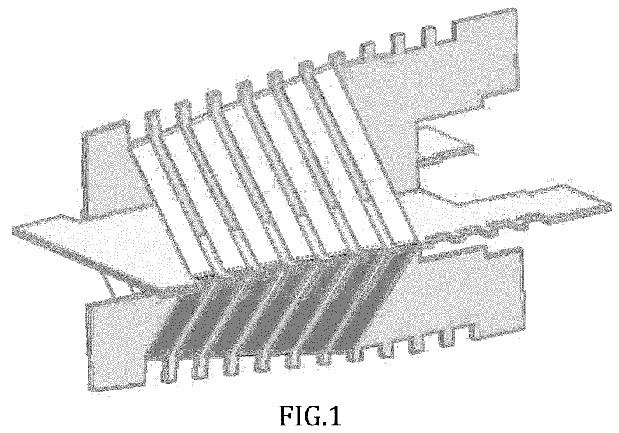

FIG. 2 Shows temperature and power vs time in seconds for low energy heater element.

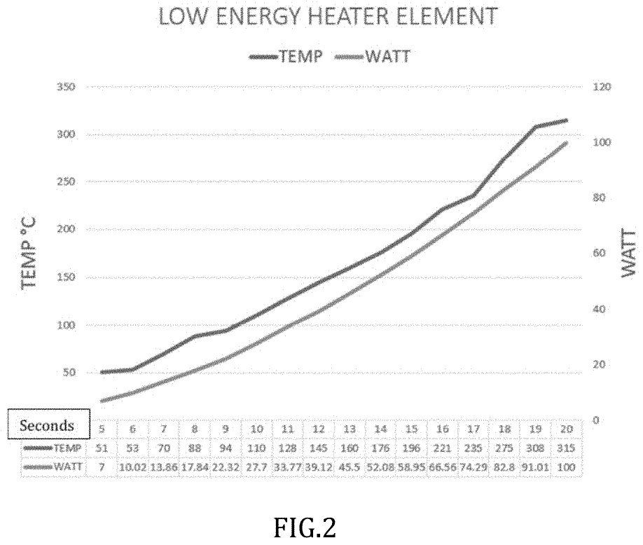

FIG. 3 showing temperature and power vs time in seconds for NiCr heater element.

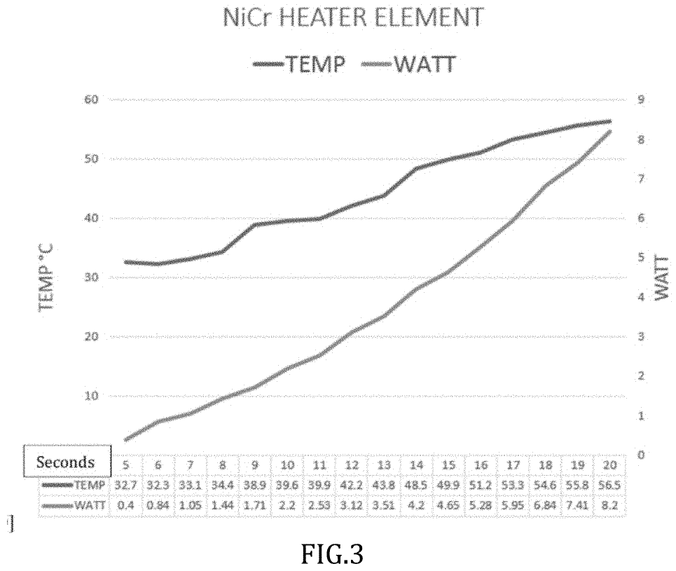

FIG. 4 showing temperature and power vs time in seconds for another NiCr heater element.

### DETAILED DESCRIPTION OF THE INVENTION

The invention encompasses a heater element comprising an electrically conducting filament coated with at least the following substances: a hafnium compound and a zirconium compound. In preferred embodiments the heater filament is coated with at least hafnium diboride and zirconium diboride, for example with at least hafnium carbide and zirconium dioxide.

The heater element may be coated with at least hafnium diboride and zirconium diboride and additionally coated with one of more compounds selected from the group consisting of: hafnium nitride (HfN), zirconium nitride (ZrN), titanium carbide (TiC), titanium nitride (TiN), thorium dioxide (ThO2) and tantalum carbide (TaC). The filament may be additionally coated with one of more compounds selected from the group consisting of graphite, silica carbide, and yttrium aluminum garnet.

The filament may additionally be surrounded by a partial vacuum, for example by a vacuum of less than 380 mm Hg.

In various embodiments the invention is directed to electrical heating elements made from steel, copper, Nichrome, Iron-Chromium-Aluminum alloys, Cupronickel, and Platinum, and coated with at least the following: zirconium carbide, zirconium dioxide, hafnium carbide and tantalum carbide, and with various combinations of other heat-insulating and electrically-insulating materials.

In certain embodiments the invention encompasses a heater element made from a metal ribbon coated with chemical mixture of graphite and zirconia, or graphite and silica carbide, or other highly retractile, heat resistant insulating materials.

In certain embodiments, the present invention includes heating elements coated with hafnium diboride and zirconium diboride. In other embodiments the coatings may be one or more of graphite and/or silica carbide and/or hafnium carbide and/or tantalum carbide and/or titanium diboride and/or yttrium aluminum garnet in various combinations. In a specific embodiment, the present invention recites heating elements coated with at least (including but not limited to) the following: zirconium carbide, zirconium dioxide, hafnium carbide and tantalum carbide. It is believed by the applicant that this combination of coatings is unique and novel in the field of coating a heating filament, and has been selected for its effect on heat production using low energy input through a DC current.

The heater element of the invention has improved heat efficiency and can generate heat rapidly. The electricity conversion ration reaches almost 99.99% and the surface temperature on the heating element can be adjusted according to the design, surface area, length and structural design required.

The disclosed heater element is coated with chemical mixture of graphite and zirconia to ensure thermal lost is kept to below 0.2%. The heater design uses low voltage DC which is safer than AC and prevents short circuits.

Coatings. The metal ribbon is coated with highly retractile, heat resistant insulating materials. Such coatings may include ceramics, resins, zirconium, titanium dioxide, or chemical mixtures of graphite and zirconia, or graphite and silica carbide.

Zirconium is a preferred insulating coating and can be produced as a number of related compounds including oxychloride, hydrochloride, orthosulphate and acetates.

Ceramics like titanium dioxide and zirconium dioxide are good insulators and highly heat resistant and can be applied by dipping, spraying or painting onto a metal surface. Other ultrahigh temperature ceramic coatings that have proven thermal stability and excellent high-temperature mechanical properties may be used including hafnium carbide, tantalum carbide, or zirconium carbide, titanium diboride, yttrium aluminum garnet.

The heating element (filament) is generally any electrically conductive substance in the form of a ribbon, though may be a wire on any other shape including a plate or lattice, and is generally made from a ferrous metal such as steel, or a ferrous alloy, or a nickel-chromium alloy, a nickel-titanium alloy, an iron-chromium-aluminum alloy, an iron-chromium alloy, a cupronickel alloy, titanium, and platinum.

In the present disclosure, the heating filament may be surrounded by a chamber enclosing a vacuum. Partial vacuum refers to an air pressure of 50% or less of an atmosphere, which is 101,325 Pa (1,013.25 hPa; 1,013.25 mbar), equivalent to 760 mm Hg. Alternatively a vacuum of 75%, 25%, 10% or 5% or 1% of an atmosphere (or any range between these numbers) may be used. A standard vacuum of the invention may be from about 1000 mPa to 100 nPa. Ultra-high vacuum s may be used down to 10⁻¹² of atmospheric pressure (100 nPa). The chamber may be made of glass or any other suitable material. The vacuum will act as a thermal insulator, but heat will leave the filament via electromagnetic radiation, for example infa-red radiation.

A general embodiment of the invention encompasses a heating element coated (plated) with a combination of a graphite material (or graphene or other carbon-based material) and zirconia. The coating is chemically bonded to the heating element and is highly thermally insulating. When a DC current of, for example, 5 Amps is passed through the heating element, using a potential difference of 12 Volts, the element will reach about 1000 Degree Centigrade with a power input of, for example, 60 Watts.

In a typical embodiment, the heating element is made of a metal or metal alloy. For example, a nickel-chromium alloy.

In another embodiment, the heating element is made from a combination of an alloy of iron mixed with the nickel and chromium before the plating process. Other materials include nickel-titanium alloys, Nichrome, iron-chromium and aluminum alloys, cupronickel, titanium, palladium and platinum.

In other embodiments heating element may be made from any metal alloy that can achieve high temperatures without melting. Examples of nickel alloys and other high Temperature Alloys can be found at https://www.aircraftmaterials.com/datainickel/nickal.html#nickell

The disclosed heater element runs of DC power and uses much lower voltage compared to typical AC units. The present invention is more efficient and safer than the prior art, and the heating element can be heated to very high temperatures using only a few watts, for example 55 W-60 W, or in other embodiments, between 20 and 100 Watts, between 40 and 80 Watts or between 50 and 70 Watts.

The amperage of the DC current may be, for example, between 1 Amp and 50 Amps, or between 1 Amp and 50 Amps, or between 2 Amp and 40 Amps, or between 3 Amp and 30 Amps, or between 4 Amp and 20 Amps, or between 5 Amp and 10 Amps.

The voltage (potential difference) used may for example be between 1 and 120 Volts, 1 and 120 Volts, 4 and 90 Volts, 6 and 70 Volts, 8 and 50 Volts, 10 and 30 Volts, 12 and 25 Volts, or 12 and 15 Volts.

Of course, voltage and current change in direct relation to each other with the relationship V=IR when R is constant, and power used is proportional to the sum of the current and the voltage (P=IV; and P=I²R).

A typical embodiment of the invention is a heater element comprising a metal ribbon coated with an insulating compound selected from one or more of zirconia, or graphite and silica carbide. The metal ribbon may comprise a nickel-chromium alloy, a nickel-titanium alloy, an Iron-Chromium-Aluminum alloy, an iron-chromium alloy a cupronickel alloy, or titanium or platinum or other suitable metals.

In typical embodiments the metal ribbon achieves a temperature of at least 270° C. with a power input of no more than 60 W.

The heater element may, for example, have the following characteristics: the metal is a Nickel-Chromium alloy coated with a mixture of graphite and silica carbide, width between 1.0 and 6.0 mm, thickness between 0.2 and 0.6 mm, length between 100 and 400 mm, and resistance: 0.5Ω-5Ω.

A typical example of the heating strip of the invention is a ribbon made from a nickel-chromium alloy ribbon coated with a graphite and silica carbide coating with the following characteristics:

Total surface area=7946 mm2

### Resistance=3.63Ω

Strip length=903 mm
Strip thickness=0.4 mm
Strip width=4 mm
Input voltage=5V to 20V

For this typical example, temperature increases with power input with about 200 degrees centigrade achieved with an input of 60 Watts. 7 W=51° C., 10.02 W=51° C., 13.86 W=70° C., 17.84 W=88° C., 22.32 W=94° C., 27.7 W=110° C., 33.77 W=128° C., 39.12 W=145° C., 45.5 W=160° C., 52.08 W=176° C., 58.95 W=196° C., 66.5 W=221° C., 74.29 W=235° C., 82.8 W=275° C., 91.01 W=308° C., 100 W=315° C.

The heating element of the invention differs in several ways from a traditional heating element. First, of course, it is coated with a thermal insulator, second it has a larger surface area and a shorter length. It also has a lower resistance and will generally start to glow at >650° C.

Surface area for an application such as hair dryer may be for example about 2112 mm², or between 1000 and 3000 mm², or between 1500 and 2500 mm², or between 1800 and 2200 mm².

Width may be for example 4 mm, or between 1 and 10 mm, 2 and 7 mm, 3 and 5 mm.

Thickness may be for example 0.4 mm, or between 0.1 and 1 mm, or 0.2 and 0.8 mm, or 0.3 and 0.5 mm.

The length may be for example about 240 mm, or from 100 to 400 mm, from 150 to 300 mm or from 200 to 275 mm.

In one practical application, the invention provides for a a hand-held hair dryer comprising a heater element wrapped around an armature wherein a current is passed through the heating element to produce heat, wherein the heating element comprises a metal ribbon coated with a heat-insulating and non-electrically conductive compound, wherein the coating is selected from one or more of zirconia, or graphite and silica carbide, and the metal ribbon is formed from a substance selected from the group consisting of: a nickel-chromium alloy, a nickel-titanium alloy, an iron-chromium-aluminum alloy, an iron-chromium alloy, a cupronickel alloy, titanium, and platinum.

In a related embodiment, the hair dryer includes a metal ribbon that achieves a temperature of at least 100° C. with a power input of no more than 60 W.

In another related embodiment, the hair dryer operates to produce a constant and substantial flow or heated air sufficient to dry hair using a power input of no more than 60 W.

In another related embodiment, the hair dryer operates to produce a constant and substantial flow or heated air sufficient to dry hair using a power input of between 20 and 60 Watts.

Applicant is aware of a number of prior art references that disclose various heating elements, some of which are coated with various heat-resistant materials. For example Lo at al (U.S. Pat. No. 6,327,428), Manov et al. (U.S. Pat. No. 5,641,421), Etter (U.S. Pat. No. 3,029,360) and Pollak (US2002/0006275A1). Etter discloses coating of a heating wire with zirconium carbide. But it does not disclose a coating of graphite or silica carbide or hafnium carbide or tantalum carbide or titanium diboride or yttrium aluminum garnet or any combination of these elements as claimed in the present application.

### EXAMPLES OF ASPECTS OF THE INVENTION

### Example 1: Composition of Low Energy Heater Element

Element: Nickel-Chromium alloy and/or Iron Alloy

a. Coating: Chemical mixture of Graphite and Silica Carbide
b. Width: 4 mm
c. Thickness: 0.4 mm
d. Length: 240 mm
e. Total surface area: 2112 mm²
f. Volt DC: 12V
g. Current: 5 A
h. Resistance: 2Ω
i. Power: 55 W-60 W
j. Temperature@ 60 W: 270° C.

### Example 2: Low Energy Heater Element (Temp=Line Above; Watt=Line Below)

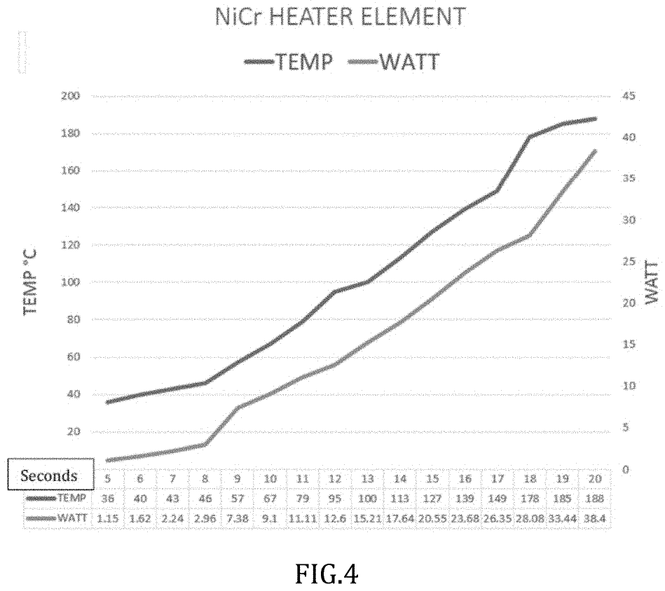

See FIG. 4 showing temperature and power vs time in seconds for low energy heater element.

### Heater Strip Spec

Total surface area=7946 mm2
Volume=1444.8 mm3
Resistance=3.63Ω
Strip length=903 mm
Strip thickness=0.4 mm
Strip width=4 mm
Input voltage=5V to 20V

### Example 3: 52.4Ω NiCr Heater Element (Temp=Line Above; Watt=Line Below)

See FIG. 5 showing temperature and power vs time in seconds for NiCr heater element.

### NiCr Heater Wire Spec

Total surface area=2393 mm2
Volume=479 mm3
Resistance=52.4Ω
Strip length=3808 mm
Strip diameter=0.4 mm
Input voltage=5V to 20V

### Example 4: 20.3Ω NiCr Heater Element (Temp=Line Above; Watt=Line Below)

See FIG. 6 showing temperature and power vs time in seconds for NiCr heater element.

### NiCr Heater Wire Spec

Total surface area=1267 mm2
Volume=253 mm3
Resistance=20.3Ω
Strip length=2016 mm
Strip diameter=0.4 mm
Input voltage=5V to 20V

### Example 5: Comparison of Low Energy Heater Element Vs. Traditional NiCr Heater Element

| LOW ENERGY HEATER ELEMENT | NiCr HEATER ELEMENT |
|---|---|
| BIG SURFAE AREA | LOW SURFACE AREA |
| SHORTER LENGTH USAGE | LONGER LENGTH USAGE |
| LOW RESISTANCE | HIGH RESISTANE |
| OPERATE IN DC OR AC VOLTAGE | OPERATE IN AC VOLTAGE |
| GENERATE HIGH HEAT AT LOW OHM | GENERATE HIGH HEAT AT HIGH OHM |
| ELEMENT START TO GLOW AT ≥650° C. | ELEMENT START TO GLOW AT ≥250° C. |
| LONGER DURABILTY LIFE | OPTIMUM DURABILITY LIFE |
| ENVIRONMENTAL FRIENDLY MATERIAL | NON ENVIRONMENTAL FRIENDLY |
| USE IN ALL TYPES OF ELECTRICAL APPL | USE IN ALL TYPES OF ELECTRICAL APPL |
| HIGH SAFETY DUE TO ABLE TO OPERATE IN | DANGER OF ELECTROCUTION DUE TO AC |
| DC VOLTAGE | VOLTAGE |

### Example 6: Electric Consumption Comparison of Low Energy Heater Element Vs. Traditional NiCr Heater Element

| COMPARISON OF ELECTRICITY | LOW ENERGY | | NiCr HEATER | |
|---|---|---|---|---|
| CONSUMPTION OF HAIR DRYER | HEATHER ELEMENT | | ELEMENT | |
| DESCRIPTION | VALUE | | VALUE | |
| Usage per day | 8 | hrs | 8 | hrs |
| No of days use per month | 25 | days | 25 | days |
| Average cost per KWh | 0.3166 | cent | 0.3166 | cent |
| Power of heater element | 60 | W | 1000 | W |
| Estimated usage per day(KWh) | 0.40 | kWh | 6.67 | KWh |

| | | |
|---|---|---|
| Estimated charge per day, RM | RM0.13 | RM2.11 |
| Estimated charge per mth, RM | RM3.80 | RM63.32 |
| 5 PCS OF HAIR DRYER IN A HAIR SALOON, | RM19 | RM316.60 |
| TOTAL ELECTRICITY PER MONTH | | |

### Further Examples of Commercial Aspects of the Invention

Some commercial embodiments include heating elements made from steel, copper, Nichrome, Iron-Chromium-Aluminum alloys, Cupronickel, and Platinum, and coated with at least a combination of the following: zirconium carbide, zirconium dioxide, hafnium carbide and tantalum carbide, and with various combinations of other heat-insulating and electrically-insulating materials.

In the present invention, important coatings include early transition metal borides such as hafnium diboride (HfB2) and zirconium diboride (ZrB2). Additional UHTCs under investigation for TPS applications include hafnium nitride (HfN), zirconium nitride (ZrN), titanium carbide (TiC), titanium nitride (TiN), thorium dioxide (ThO2), tantalum carbide (TaC) and their associated composites. Any of these may be used in the invention.

Various combinations include:

Zirconium dioxide only or non-exclusively. Zirconium carbide and zirconium dioxide only or non-exclusively. Zirconium carbide and zirconium dioxide and hafnium carbide only or non-exclusively. Zirconium carbide and zirconium dioxide and hafnium carbide and tantalum carbide only or non-exclusively. Hafnium carbide and tantalum carbide only or non-exclusively. Zirconium dioxide and hafnium carbide and tantalum carbide only or non-exclusively. Hafnium carbide only or non-exclusively. Tantalum carbide only or non-exclusively. Any of the above coatings may also include graphite or graphene or silica.

Other commercial embodiments include heater element made from a metal ribbon coated with chemical mixture of graphite and zirconia, or graphite and silica carbide, or other highly retractile, heat resistant insulating materials.

The heating elements of the invention require low power output and consume approximately 6% of the energy used by a conventional non-coated heating element which operates only on AC current. Additionally, use of DC current improves safety and transmission efficiency.

In certain commercial embodiments the filament is coated with graphene only about 1 atom in thickness.

Alternatively multiple layers of nano-carbon material may be laid over the heater element to achieve higher potential of energy efficiency at lower power input levels. Multiple layers of nano carbon material afford the safe & fast transfer of high powered energy. These commercial heating elements are particularly suitable for use in water heaters, boilers, plastic injection molding machines, heat flanging equipment, ovens, hot plates, home heaters, electric kettles, and wherever conventional heater elements are used.

### Definitions

Zirconia: Zirconium dioxide, sometimes known as zirconia, is a white crystalline oxide of zirconium. A dopant stabilized cubic structured zirconia; cubic zirconia is synthesized in various colors for use as a gemstone and a diamond stimulant.

Graphene is a semi-metal with a small overlap between the valence and the conduction bands. It is an allotrope of carbon consisting of a single layer of carbon atoms arranged in a hexagonal lattice. It is the basic structural element of many other allotropes of carbon, such as graphite, diamond, charcoal, carbon nanotubes and fullerenes.

Heating element: any component that functions to radiate or conduct heat to the environment such as a metal filament or ribbon, often wrapped around an armature. The heating element may also be in the form of a plate, or any other shaped component. Heating is provided by passing a current through the heating element.

Heat resistant: resisting heat up to at least 1000 degrees centigrade with no apparent physical deterioration.

Ribbon: refers to any elongated and flattened component with an approximately rectangular aspect ratio.

Armature: a non-electrically conducting scaffolding structure around which the heating element is wound.

In the present disclosure, a partial vacuum refers to an air pressure of 50% or less of an atmosphere, which is 101,325 Pa (1,013.25 hPa; 1,013.25 mbar), equivalent to 760 mm Hg. Alternatively a vacuum of 75%, 25%, 10% or 5% or 1% of an atmosphere (or any range between these numbers) may be used. A standard vacuum of the invention may be from about 1000 mPa to 100 nPa. Ultra-high vacuum s may be used down to 10⁻¹² of atmospheric pressure (100 nPa). Generally a low vacuum is considered to be 1×10⁵ to 3×10³ Pa, a medium vacuum is considered to be 3×10³ to 1×10⁻¹ Pa, and a high vacuum is considered to be 1×10⁻¹ to 1×10⁻⁷ Pa. Any of these pressures or pressures between these, may be used in the invention.

### GENERAL DISCLOSURES

This specification incorporates by reference all documents referred to herein and all documents filed concurrently with this specification or filed previously in connection with this application, including but not limited to such documents which are open to public inspection with this specification. All numerical quantities mentioned herein include quantities that may be plus or minus 20% of the stated amount in every case, including where percentages are mentioned. As used in this specification, the singular forms “a, an”, and “the” include plural reference unless the context clearly dictates otherwise. Thus, for example, a reference to “a part” includes a plurality of such parts, and so forth. The term “comprises” and grammatical equivalents thereof are used in this specification to mean that, in addition to the features specifically identified, other features are optionally present. For example, a composition “comprising” (or “which comprises”) ingredients A, B and C can contain only ingredients A, B and C, or can contain not only ingredients A, B and C but also one or more other ingredients. The term “consisting essentially of” and grammatical equivalents thereof is used herein to mean that, in addition to the features specifically identified, other features may be present which do not materially alter the claimed invention. The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Where reference is made in this specification to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps (except where the context excludes that possibility). When, in this specification, a range is given as “(a first number) to (a second number)” or “(a first number)-(a second number)”, this means a range whose lower limit is the first number and whose upper limit is the second number. For example, “from 40 to 70 microns” or “40-70 microns” means a range whose lower limit is 40 microns, and whose upper limit is 70 microns. When specific numbers are mentioned, it is implied that any range between these numbers may be used. For example if numbers 1, 5, 10 and 20 are mentioned, it is implied that ranges 1-20, 1-10, 1-5, 5-20, 5-20 etc. may also be used.

Note that when various coatings are listed in the, the invention also implicitly encompasses combinations of compounds including other compounds, OR lists of compounds EXCLUDING additional compounds, i.e., “comprising” the listed compounds.

### REFERENCES

All the below references are incorporated by reference.
Wuchina, E.; et al. (2007). “UHTCs: ultra-high temperature ceramic materials for extreme environment applications”. The Electrochemical Society Interface. 16: 30.
Zhang, Guo-Jun; et al. (2009). “Ultrahigh temperature ceramics (UHTCs) based on ZrB2 and HfB2 systems: Powder synthesis, densification and mechanical properties”. Journal of Physics: Conference Series. 176 (1): 012041. Bibcode:2009JPhCS.176a2041Z. doi:10.1088/1742-6596/176/1/012041.
Lawson, John W., Murray S. Daw, and Charles W. Bauschlicher (2011). “Lattice thermal conductivity of ultra high temperature ceramics ZrB2 and HfB2 from atomistic simulations”. Journal of Applied Physics. 110 (8): 083507-083507-4. Bibcode:2011JAP . . . 110h3507L. doi:10.1063/1.3647754. hdl:2060/20110015597.
Monteverde, Frédéric & Alida Bellosi (2004). “Efficacy of HfN as sintering aid in the manufacture of ultrahigh-temperature metal diborides-matrix ceramics”. Journal of Materials Research and Technology. 19 (12): 3576-3585. Bibcode:2004JMatR . . . 19.3576M. doi:10.1557/jmr.2004.0460.
Zhao, Hailei; et al. (2007). “In situ synthesis mechanism of ZrB2-ZrN composite”. Materials Science and Engineering: A. 452: 130-134. doi:10.1016/j.msea.2006.10.094.
Zhu, Chun-Cheng, Xing-Hong Zhang, and Xiao-Dong He. (2003). “Self-propagating High-temperature Synthesis of TiC-TiB2/Cu Ceramic-matrix Composite”. Journal of Inorganic Materials. 4: 026.
Chen. T J (1981). “Fracture characteristic of ThO2 ceramics at high-temperature”. American Ceramic Society Bulletin. 60: 923.
Curtis, C. E. & J. R. Johnson. (1957). “Properties of thorium oxide ceramics”. Journal of the American Ceramic Society. 40 (2): 63-68. doi:10.1111/j.1151-2916.1957.tb12576.
Wang, Yiguang; et al. (2012). “Oxidation Behavior of ZrB2-SiC—TaC Ceramics”. Journal of the American Ceramic Society.
Sannikova, S. N., T. A. Safronova, and E. S. Lukin. (2006). “The effect of a sintering method on the properties of high-temperature ceramics”. Refractories and Industrial Ceramics. 47 (5): 299-301. doi:10.1007/s11148-006-0113-y.

1. A heater element comprising an electrically conducting filament coated with at least the following substances: a hafnium compound and a zirconium compound.

2. The heater element of claim 1 wherein the electrically conducting filament is coated with at least hafnium diboride and zirconium diboride.

3. The heater element of claim 1 wherein the electrically conducting filament is coated with at least hafnium carbide and zirconium dioxide.

4. The heater element of claim 1 additionally coated with a tantalum compound.

5. The heater element of claim 4 wherein the tantalum compound is tantalum carbide.

6. The heater element of claim 1 additionally coated with a zirconium compound.

7. The heater element of claim 6 wherein the zirconium compound is selected from the group consisting of oxychlorides, hydrochlorides, orthosulphates and acetates.

8. The heater element of claim 6 wherein the zirconium compound is zirconium carbide.

9. The heater element of claim 1 coated with at least a hafnium compound, a zirconium compound and a tantalum compound.

10. The heater element of claim 8 coated with at least hafnium diboride and zirconium diboride and tantalum carbide.

11. The heater element of claim 2 wherein the electrically conducting filament is coated with at least hafnium diboride and zirconium diboride and is additionally coated with one of more compounds selected from the group consisting of: hafnium nitride (HfN), zirconium nitride (ZrN), titanium carbide (TiC), titanium nitride (TiN), thorium dioxide (ThO2) and tantalum carbide (TaC).

12. The heater element of claim 2 wherein the electrically conducting filament is additionally coated with one of more compounds selected from the group consisting of graphite, silica carbide, and yttrium aluminum garnet.

13. The heater element of claim 2 wherein the electrically conducting filament is additionally surrounded by a partial vacuum.

14. The heater element of claim 2 wherein the electrically conducting filament is additionally surrounded by a vacuum of less than 380 mm Hg.

15. The heater element of claim 2 wherein the electrically conducting filament is made of tungsten.

16. The heater element of claim 2 where the coatings consist of only hafnium diboride and zirconium diboride.

17. The heater element of claim 2 where the coatings consist of only hafnium carbide and zirconium dioxide.

18. The heater element of claim 2 where the coatings consist of only hafnium diboride and zirconium diboride and tantalum carbide.

19. The heater element of claim 2 where the coatings consist of only hafnium carbide and zirconium dioxide and tantalum carbide.

20. The heater element of claim 19 additionally surrounded by a vacuum of less than 380 mm Hg.
